(19) United States
(12) Patent Application Publication
(10) Pub. No.: US 2011/0015286 A1
(43) Pub. Date: Jan. 20, 2011

(54) PROCESS FOR THE PREPARATION OF EXPANDABLE POLYSTYRENE

(76) Inventors: Pascal Nicol, Saint Genis Laval (FR); Jacques Cochet, Chanas (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 12/933,751

(22) PCT Filed: Mar. 13, 2009
(86) PCT No.: PCT/EP2009/053011

§ 371 Date: Sep. 21, 2010

(30) Foreign Application Priority Data
Mar. 27, 2008 (EP) 08356055.7

(51) Int. Cl. C08J 9/30

(52) U.S. Cl. 521/72

(57) ABSTRACT

The present invention relates to a process for the preparation of expandable polystyrene comprising the following steps: i^{o}) heating an aqueous suspension comprising styrene monomer and at least one organic peroxide initiator of formula (I) 1-alkoxy-1-t-alkylperoxycyclohexane in which the alkoxy group contains 1 to 4 carbon atoms, the t-alkyl group contains 4 to 12 carbon atoms, and the cyclohexane ring may optionally be substituted with 1 to 3 alkyl groups each, independently having 1 to 3 carbon atoms, at a temperature ranging from 100° C. to 120° C., ii^{o}) adding a blowing agent selected from the group consisting of alkanes having from 4 to 6 carbon atoms and mixtures thereof. The invention also relates to an expandable polystyrene obtainable according to such a process and to insulation parts and packaging comprising such an expandable polystyrene.

The present invention relates to a process for the preparation of expandable polystyrene and to an expandable polystyrene obtainable by such a process.

A known method for producing expandable polystyrene polymers, hereinafter referred to as EPS, is by aqueous suspension polymerization. It is typically a batch process where two or more monomer-soluble polymerization initiators are used with a rising stepwise, continuous, or combination temperature profile. Initiators for the process are selected on the basis of their half life temperatures to provide a measured supply of radicals at selected points along the temperature profile such that effective conversion occurs within an acceptable period of time. For styrene polymerization, it is convenient to describe initiator decomposition performance in terms of one hour half life temperature, defined as that temperature sufficient to cause decomposition of one half of the starting concentration of initiator over a one hour time period.

Traditionally, suspension polymerization to prepare EPS is conducted in a process using two different temperature stages and two initiators, a first stage initiator and a second stage or “finishing” initiator, with different half life temperatures, each appropriate for the particular temperature stage. In such a process, dibenzoyl peroxide (BPO) is often used as the first stage initiator at a reaction temperature of about 82° C. to 95° C. Other first stage initiators useful in this temperature range might include tertiary butyl peroxy-2-ethylhexanoate, tertiary amyl peroxy-2-ethylhexanoate and 2,5-dimethyl-2,5-di(2-ethylhexanoylperoxy)hexane. Initiators such as tertiary butyl peroxybenzoate (TBP) or dicumyl peroxide (DCP) are widely used for the higher temperature stage, or second stage, at 115° C. to 135° C. The second stage is usually a finishing step intended to minimize residual monomer in the EPS. In commercial processing, this stage is often held above 125° C. for prolonged intervals to reduce monomer content to acceptable levels.

Characteristic shortcomings of the traditional process are long reaction times necessary to obtain adequate conversion in the first stage and relatively high finishing temperatures required in the second stage.

In view of alleviating this drawback, document U.S. Pat. No. 6,608,150 has proposed an improved process for the preparation of expandable polystyrene in which “intermediate” temperature peroxides, that is to say initiator peroxides having a one hour half life temperature ranging from 101° C. to 111° C., are used. According to this document, the use of such “intermediate” peroxides in the preparation of expandable polystyrene allows to reduce the conversion time for some hours.

Expandable polystyrene, as prepared in the suspension process, is in the form of essentially spherical beads. It is mentioned in U.S. Pat. No. 6,608,150 that some blowing agent, such as pentane, may be used in the process in order to render the polystyrene beads expandable.

However, it is known that the use of pentane in a process of preparation of expandable polystyrene leads to a decrease in the molecular weight as a result of transfer mechanism on the alkane agent (see Principles of Polymerization-George Odian p 203-217,McGraw-Hill Book Company 1970).

Additionally, it is more and more requested in the industry that the polystyrene resins comprise flame retardant additives for safety reasons. For instance, flame retarded resins are widely used in insulation applications. The addition of such additives may also lead to a decrease of the molecular weight of the resulting polystyrene.

It appears then that several factors may lead, in the preparation process of expandable polystyrene, to a significant decrease of the molecular weight of such expandable polystyrene.

By “molecular weight” is meant according to the present application the weight average molecular weight (Mw). According to the present invention, the molecular weight is measured according to the SEC (Size Exclusion Chromatography) method using Polystyrene standards.

It is important that the expandable polystyrene has a high molecular weight in order to guarantee the mechanical properties of the final materials.

The Applicant has now discovered that by using a specific initiator peroxide, it was possible to accelerate the preparation of expandable polystyrene while using a blowing agent and to still obtain polystyrene having a particularly high molecular weight.

A first aspect of the invention relates to a process for the preparation of expandable polystyrene comprising the following steps:
-i^{o}) heating an aqueous suspension comprising styrene monomer and at least one organic peroxide initiator of formula (I) 1-alkoxy-1-t-alkylperoxycyclohexane in which the alkoxy group contains 1 to 4 carbon atoms, the t-alkyl group contains 4 to 12 carbon atoms, and the cyclohexane ring may optionally be substituted with 1 to 3 alkyl groups each, independently having 1 to 3 carbon atoms, at a temperature ranging from 100° C. to 120° C.,
-ii^{o}) adding a blowing agent selected from the group consisting of alkanes having from 4 to 6 carbon atoms and mixtures thereof. The process according to the invention allows obtaining expandable polystyrene showing high molecular weight. Preferably, the expandable polystyrene obtainable according to the process of the invention shows a molecular weight (Mw) of at least 170,000 g/mol, preferably of at least 175,000 g/mol, and more preferably of at least 190,000 g/mol.

Because of its high molecular weight, the expandable polystyrene according to the invention may be used efficiently in insulation or packaging applications.

Moreover, the process of the invention has a conversion time reduced compared to the ones of the prior art. The process of the invention uses at least one organic peroxide initiator of formula (I), ie 1-alkoxy-1-t-alkylperoxycyclohexane in which the alkoxy group contains 1 to 4 carbon atoms, the t-alkyl group contains 4 to 12 carbon atoms, and the cyclohexane ring may optionally be substituted with 1 to 3 alkyl groups each, independently having 1 to 3 carbon atoms.

According to the present invention, it has been found that the use of such a specific organic peroxide of formula (I) in combination with a blowing agent such as an alkane having from 4 to 6 carbon atoms and mixtures thereof allowed to obtain expandable polystyrene having a high molecular weight, in a short time. Such a result could not be obtained with other organic peroxides, having a one hour half life temperature similar to that of compounds of formula (I) but having a chemical formula different than formula (I).

As organic peroxides of formula (I) one can cite 1-alkoxy-1-t-amylperoxycyclohexane and 1-alkoxy-1-t-hexylperoxycyclohexane, where the alkoxy group contains 1 to 4 carbon atoms, and the cyclohexane ring may optionally be substituted with 1 to 3 alkyl groups each, independently having 1 to 3 carbon atoms.

In an embodiment of the invention, the at least one organic peroxide initiator is 1-methoxy-1-t-amylperoxycyclohexane (also referred hereinafter as TAPMC).

The organic peroxide initiator of formula (I) is used in a first step i^{o}) of the process of the invention, during which said organic peroxide initiator is heated at a temperature ranging from 100° C. to 120° C. In an embodiment of the invention, this temperature ranges from 105° C. to 115° C., preferably is 110° C. Such a temperature is close to the one hour half life temperature of the organic peroxides of formula (I), as measured according to the well-known technique of measuring the rate of initiator decomposition in the aromatic solvent cumene. Indeed, in a preferred embodiment of the invention, the organic peroxides of formula (I) are used as first stage initiators. In such a case, preferably, the organic peroxides of formula (I) are heated at said temperature of 100° C. to 120° C., preferably 105° C. to 115° C., and more preferably of 110° C., for a time sufficient to effect at least partial decomposition of said initiator and initiate polymerization of the styrene monomer. This time may range from about 1.5 hours to about 3 hours.

In an embodiment of the invention, the aqueous suspension of step) i^{o}) further comprises at least one additional organic peroxide initiator, different from said organic peroxide initiator of formula (I).

Preferably, said additional organic peroxide initiator plays the role of the second stage initiator. When the aqueous suspension of step i^{o}) comprises an organic peroxide initiator of formula (I) as first stage initiator and at least one additional other organic peroxide initiator as second stage initiator, step i^{o}) comprises a first stage, during which said suspension is heated at a temperature ranging from 100° C. to 120° C., preferably from 105° C. to 115° C., and more preferably to 110° C., and a second stage during which said suspension is heated at a temperature corresponding to the one hour half life temperature of the at least additional other organic peroxide.

Said additional peroxide initiator may be selected among any organic peroxide initiator different from formula (I) and having a one hour half life temperature, as measured according to the well-known technique of measuring the rate of initiator decomposition in the aromatic solvent cumene, above 110° C. In an embodiment of the invention, the additional peroxide initiator is selected from the group consisting of compounds having the formula (II), ie OO-t-alkyl-O-alkyl monoperoxycarbonate, wherein t-alkyl contains from 4 to 12 carbon atoms, preferably from 4 to 5 carbon atoms, and alkyl contains from 3 to 12 carbon atoms, and preferably 8 carbon atoms, and their mixtures.

In an embodiment of the process of the invention, the at least additional peroxide initiator is OO-t-amyl-O-2-ethylhexyl monoperoxycarbonate (also referred to hereinafter as TAEC).

In another embodiment of the process of the invention, the at least additional peroxide initiator is OO-t-butyl-O-2-ethylhexyl monoperoxycarbonate (also referred to hereinafter as TBEC).

These products are respectively commercially available from the company ARKEMA under the tradename “Luperox® TAEC” and “Luperox® TBEC”.

In an embodiment of the process of the invention, in particular when OO-t-amyl-O-2-ethylhexyl monoperoxycarbonate or OO-t-butyl-O-2-ethylhexyl monoperoxycarbonate is used as the second stage initiator, the aqueous suspension is heated, during said second stage, at a temperature ranging from 120° C. to 140° C., preferably at a temperature of about 130° C. Said second stage may last from 1 to 3 hours.

In an embodiment of the process of the invention, said first stage lasts about 2 to 3 hours and said second stage lasts about 2 hours.

In another embodiment of the process of the invention, the organic peroxide of formula (I) plays the role of the second stage initiator and said additional peroxide initiator plays the role of the first stage initiator.

In an embodiment of the invention, said organic peroxide initiator of formula (I) is used in the aqueous suspension of step i^{o})in amounts from 4 to 25 milli equivalents of initiator per liter of styrene, more preferably from 12 to 20 milli equivalents of initiator per liter of styrene.

Styrene is the preferred monomer for the process of the invention. However, up to 15% of the weight of styrene may be replaced by other ethylenically unsaturated copolymerizable monomers such as alkylstyrenes, alpha methylstyrene, acrylic acid esters and acrilonitrile. For example, the styrene monomer to be polymerized may also contain up to 15 weight %, with respect to the total weight of styrene, of copolymerizable monomers other than styrene monomers.

In an embodiment of the invention, said additional organic peroxide initiator used in the aqueous suspension of step i^{o}) in amounts from 1 to 20 milli equivalents of initiator per liter of styrene, more preferably from 2 to 10 milli equivalents of initiator per liter of styrene.

The process of the invention also comprises a step, step ii^{o}), of addition of a blowing agent selected from the group consisting of alkanes having 4 to 6 carbon atoms and mixtures thereof.

The blowing agent may be added to the aqueous suspension at any time during step i^{o}), or after step i^{o}) is completed.

In an embodiment of the invention, the blowing agent is added during step i^{o}), ie during the polymerization of the styrene monomer. In such a case, when step i^{o}) comprise a first and a second stages, the blowing agent may be added during the first stage of step i^{o}). For instance, the blowing agent may be added at the end of the first stage of step i^{o}).

In another embodiment of the invention, the spherical beads of polystyrene obtained at the end of step i^{o}) are segregated by size and the blowing agent is added to the segregated spherical beads. This embodiment of the process allows a more precise control of the bead sizes.

In an embodiment of the invention, said blowing agent is selected from the group consisting of butane, 2-methylbutane, pentane, cyclohexane and mixtures thereof. Such blowing agents are well known products which are commercially available.

Preferably, said blowing agent is pentane.

In an embodiment of the invention, the blowing agent is added in amounts ranging from 5 to 10%, by weight, with respect to the weight of styrene.

In an embodiment of the invention, an additive selected from the group comprising flame retardant agents, inorganic suspension stabilizers, such as calcium phosphate or magnesium pyrophosphate, organic suspension stabilizers, such as polyvinylpyrrolidone, polyvinyl alcohol or hydroxyethylcellulose, surfactants, chain transfer agents, nucleating agents, expansion aids, lubricants, plasticizers and mixtures thereof, is added to the aqueous suspension at step i^{o}) or at step ii^{o}).

The flame retardant agent may be selected from the group comprising hexabromocyclododecane (HBCD), tetrabromobisphenol A (TBBPA), decabromodiphenyl ether (Deca—BDE), pentabromodiphenyl ether (Penta—BDE), octabromodiphenyl ether (Octa—BDE), tris-(dibromopropyl)phosphate, carbon tetrabromide, beta-d ibromopropionate, tetrabromoethylene, 1-2-dibromo-1,1,2,2-tetrachloroethane, 1,1,2,2-tetrabromoethane, dibromodichloroethane, 1,2-dibromo-1,1-dichloroethane, 1,2-dibromo-1,2,2-trichloroethane, 1,2,3,4-tetrabromobutane, 1,2,3-tribromopropane, pentabromoethane, tribromotrichlorocyclohexane, 1,2,4-tribromobutane, tetrabromopentane, hexabromoethane, tetrabromodichlorocyclohexane, pentabromomonochlorocyclohexane, 1,2-di-(dibromomethyl)benzene, alpha,beta-dibromoethylbenzene, alpha,beta-dibromopropionate and mixtures thereof.

Preferably, the flame retardant agent is hexabromocyclododecane.

Another aspect of the invention relates to an expandable polystyrene obtainable by the process described above. Such an expandable polystyrene shows a high molecular weight and is therefore useful in insulation or packaging applications. For example, the expandable polystyrene according to the invention may be used in the manufacture of insulation parts, for example in the transport industry. The expandable polystyrene according to the invention may also be used in the manufacture of packaging having good mechanical properties. A further aspect of the invention relates to insulation parts comprising an expandable polystyrene according to the invention. Another aspect of the invention relates to packagings comprising an expandable polystyrene according to the invention.

The present invention will now be further illustrated by means of the following examples.

### EXAMPLES

In all examples hereinbelow, the molecular weight of the product obtained is measured according to the method given hereinabove in the description of the present application.

### Example 1

### Preparation of 1-Methoxy-1-t-Amylperoxycyclohexane (TAPMC)

A mixture of t-amyl hydroperoxide (TAHP), cyclohexanone and methanol is treated with 70% sulfuric acid at −6° to −4° C. In fifteen minutes, an equilibrium mixture of 1-methoxy-1-t-amylperoxycyclohexane, 1,1-di-(t-amylperoxy)-cyclohexane and the unreacted starting materials cyclohexanone and TAHP is formed. Small amounts (≈2%) of cyclohexane-1,1-dimethyoxyketal (CDMK) are also produced in the reaction mixture. The reaction mixture is quenched with cold water and the aqueous phase is separated from the organic phase, which is purified by washing.

### Example 2

### Invention

Into a 2 liter pressure vessel of the Büchi type, equipped with a double envelop and specific stirring means (4 blade stirrer) were added at 20° C. and under stirring 680 g of deionized water with 0.64 g of polyvinyl alcohol (Alcotex® 72.5 available from the company HARCO). Were further added 320 g of styrene monomer with 1.02 g of 1-methoxy-1-t-amylperoxycyclohexane (TAPMC) as obtained in Example 1 above, and 0.42 g of OO-t-amyl O-2-ethylhexyl monoperoxycarbonate (TAEC available under the trademark Luperox® TAEC from the company ARKEMA). This aqueous suspension was heated at 110° C. and maintained at this temperature for 2.5 hours for the first polymerization stage. In this example, 1-methoxy-1-t-amylperoxycyclohexane is used as first stage initiator.

After 2.5 hours, were further added 21.1 g of pentane in two minutes using a high pressure pump. The reaction medium was then heated at 130° C. and maintained at this temperature for 2 hours. In this example, OO-t-amyl O-2-ethylhexyl monoperoxycarbonate is used as second stage initiator.

The reaction medium was then cooled down. The obtained polystyrene beads are collected by filtration and dried.

The obtained product has a molecular weight (Mw) of 226,000 g/mol with 700 ppm of residual styrene monomer.

The high value of the molecular weight of the expandable polystyrene obtained in the present example is useful to secure further mechanical properties for the final material comprising said expandable polystyrene, such as resistance under loading, flexural and tensile strength at break.

### Example 3

### Invention

The same process as in Example 2 is repeated with the same amounts except that the 0.42 g of TAEC is replaced by 0.42 g of OO-t-butyl O-2-ethylhexyl monoperoxycarbonate (Luperox® TBEC available from the company ARKEMA).

In this example, 1-methoxy-1-t-amylperoxycyclohexane is used as first stage initiator and OO-t-butyl O-2-ethylhexyl monoperoxycarbonate is used as second stage initiator.

The obtained product has a molecular weight (Mw) of 220,000 g/mol with 500 ppm of residual styrene monomer.

The high value of the molecular weight of the expandable polystyrene obtained in the present example is useful to secure further mechanical properties for the final material comprising said expandable polystyrene, such as resistance under loading, flexural and tensile strength at break.

### Example 4

### Invention

The same process as in Example 2 is repeated with the same amounts except that 2.1 g of hexabromocyclododecane is added at the aqueous suspension of styrene monomer.

The obtained product has a molecular weight (Mw) of 195,000 g/mol with 970 ppm of residual styrene monomer.

Thus, thanks to the process of the invention, it is possible to obtain flame retardant expandable polystyrene having a high molecular weight. The final materials comprising an expandable polystyrene such as the one obtained in the present example show good insulation properties and good mechanical properties, such as resistance under loading, flexural and tensile strength at break.

### Example 5

### Comparative

Into a 2 liter pressure vessel of the Büchi type, equipped with a double envelop and specific stirring means (3 blade stirrer on two levels) were added at 20° C. and under stirring 680 g of deionized water with 0.64 g of polyvinyl alcohol (Alcotex® 72.5 available from the company HARCO). Were further added 320 g of styrene monomer with 1.44 g of dibenzoyle peroxide (Luperox® A75 available from the company ARKEMA), and 0.42 g of OO-t-amyl O-2-ethylhexyl monoperoxycarbonate (TAEC available under the trademark Luperox® TAEC from the company ARKEMA). This aqueous suspension was heated at 90° C. and maintained at this temperature for 4 hours for the first polymerization stage. In this example, dibenzoyle peroxide is used as the first stage initiator.

After 4 hours, were further added 21.1 g of pentane in two minutes using a high pressure pump. The reaction medium was then heated at 130° C. and maintained at this temperature for 2 hours. In this example, OO-t-amyl O-2-ethylhexyl monoperoxycarbonate is used as second stage initiator.

The reaction medium was then cooled down. The obtained polystyrene beads are collected by filtration and dried.

The obtained product has a molecular weight (Mw) of 158,000 g/mol with 970 ppm of residual styrene monomer. This molecular weight is well below that obtained for the expandable polystyrene obtained according to the inventive example 2. The polystyrene obtained according to the process of the present comparative example exhibits lower molecular weight as that of inventive example 2, with possible degradation on mechanical properties of final material.

### Example 6

### Comparative

The same process as in Example 5 is repeated with the same amounts except that the 0.42 g of TAEC is replaced by 0.42 g of OO-t-butyl O-2-ethylhexyl monoperoxycarbonate (Luperox® TBEC available from the company ARKEMA) The obtained product has a molecular weight (Mw) of 169,000 g/mol with 800 ppm of residual styrene monomer. This molecular weight is well below that obtained for the expandable polystyrene obtained according to the inventive example 3 and the polystyrene obtained according to the present comparative example shows possible degradation on mechanical properties of final material.

### Example 7

### Comparative

The same process as in Example 5 is repeated with the same amounts except that 2.1 g of hexabromocyclododecane is added at the aqueous suspension of styrene monomer.

The obtained product has a molecular weight (Mw) of 153,000 g/mol with 1600 ppm of residual styrene monomer. This molecular weight is well below that obtained for the expandable polystyrene obtained according to the inventive example 4 and the polystyrene obtained according to the present comparative example shows possible degradation on mechanical properties of final material.

1. Process for the preparation of expandable polystyrene comprising the following steps :
-i^{o}) heating an aqueous suspension comprising styrene monomer and at least one organic peroxide initiator of formula (I) 1-alkoxy-1-t-alkylperoxycyclohexane in which the alkoxy group contains 1 to 4 carbon atoms, the t-alkyl group contains 4 to 12 carbon atoms, and the cyclohexane ring optionally substituted with 1 to 3 alkyl groups each, independently having 1 to 3 carbon atoms, at a temperature ranging from 100° C. to 120° C.,
-ii^{o}) adding a blowing agent selected from the group consisting of alkanes having from 4 to 6 carbon atoms and mixtures thereof

2. Process according to claim 1, wherein the at least one organic peroxide initiator is 1-methoxy-1-t-amylperoxycyclohexane (TAPMC).

3. Process according to claim 1, wherein said blowing agent is selected from the group consisting of butane, 2-methylbutane, pentane, cyclohexane and mixtures thereof

4. Process according to claim 1, wherein said blowing agent is pentane.

5. Process according to claim 1, wherein the temperature of step i^{o}) ranges from 105° C. to 115° C.

6. Process according to claim 1, wherein the aqueous suspension of step i^{o})further comprises at least one second organic peroxide initiator, different from said organic peroxide initiator of formula (I).

7. Process according to claim 6, wherein said second peroxide initiator is selected from the group consisting of compounds having the formula (II), OO-t-alkyl-O-alkyl monoperoxycarbonate, wherein t-alkyl contains from 4 to 12 carbon atoms, and alkyl contains from 3 to 12 carbon atoms, and their mixtures.

8. Process according to claim 1, wherein said organic peroxide initiator of formula (I) is used in the aqueous suspension of step i^{o}) in amounts from 4 to 25 milli equivalents of initiator per liter of styrene.

9. Process according to claim 1, wherein the styrene monomer further comprises up to 15 weight %, with respect to the total weight of styrene, of copolymerizable monomers other than styrene monomers.

10. Process according to claim 1, wherein the blowing agent is added in amounts ranging from 5 to 10%, by weight, with respect to the weight of styrene.

11. Process according to claim 1, wherein an additive selected from the group consisting of flame retardant agents, inorganic suspension stabilizers, organic suspension stabilizers, surfactants, chain transfer agents, nucleating agents, expansion aids, lubricants, plasticizers and mixtures thereof, is added to the aqueous suspension at step i^{o}) or at step ii^{o}).

12. Process according to claim 11, wherein the flame retardant agent is selected from the group consisting of hexabromocyclododecane (HBCD), tetrabromobisphenol A (TBBPA), decabromodiphenyl ether (Deca—BDE), pentabromodiphenyl ether (Penta—BDE), octabromodiphenyl ether (Octa—BDE), tris-(dibromopropyl)phosphate, carbon tetrabromide, beta-dibromopropionate, tetrabromoethylene, 1-2-dibromo-1,1,2,2-tetrachloroethane, 1,1,2,2-tetrabromoethane, dibromodichloroethane, 1,2-dibromo-1,1-dichloroethane, 1,2-dibromo-1,2,2-trichloroethane, 1,2,3,4-tetrabromobutane, 1,2,3-tribromopropane, pentabromoethane, tribromotrichlorocyclohexane, 1,2,4-tribromobutane, tetrabromopentane, hexabromoethane, tetrabromodichlorocyclohexane, pentabromomonochlorocyclohexane, 1,2-di-(dibromomethyl)benzene, alpha,beta-dibromoethylbenzene, alpha,beta-dibromopropionate and mixtures thereof.

13. Process according to claim 12, wherein the flame retardant agent is hexabromocyclododecane.

14. Process according to claim 6, wherein said heating an aqueous suspension of step i^{o}) comprises a first stage and a second stages stage, said organic peroxide initiator of formula (I) being the first stage initiator and said at least one additional ether second organic peroxide being the second stage initiator, said suspension being heated at a temperature ranging from 100° C. to 120° C. during said first stage, and said suspension being heated at a temperature corresponding to the one hour half life temperature of the at least additional second organic peroxide during the second stage.

15. Process according to claim 1, wherein said blowing agent is added during step i^{o}).

16. Process according to claim 14, wherein said blowing agent is added at the end of the first stage of step i^{o}).

17. Expandable polystyrene obtainable by a process according to claim 1.

18. Expandable polystyrene according to claim 17, having a molecular weight (Mw) of at least 170, 000 g/mol.

19-20. (canceled)

21. Process according to claim 1, wherein said organic peroxide initiator of formula (I) is used in the aqueous suspension of step i^{o}) in amounts from 12 to 20 milli equivalents of initiator per liter of styrene.

22. Process according to claim 14 wherein said temperature ranges from 105° C. to 115° C.
